(19) United States
(12) Patent Application Publication
(10) Pub. No.: US 2006/0273496 A1
(43) Pub. Date: Dec. 7, 2006

(54) Method of making outsole

(76) Inventors: Tay-Yuo Chen, Taichung City (TW); Chien-Ho Chen, Taipei County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/142,386

(22) Filed: Jun. 2, 2005

(51) Int. Cl. B29C 45/14

(52) U.S. Cl. 264/571; 264/259

(57) ABSTRACT

A method of making an outsole includes the steps of a) preparing a mold and an insert, which mold having a cavity for molding an outsole, two through holes in communication between the cavity and the atmosphere, and a fence at a periphery of the cavity around each through hole, b) putting the insert into the cavity near the through holes, c) drawing air out of the through holes to suck the insert and to have the insert be closely attached to the fence, d) filling a molten plastic material into the cavity of the mold, and e) separating the molding thus formed from the mold after hardening of the filled plastic material so as to obtain a finished outsole.

### BACKGROUND OF THE INVENTION

1. Field of the Invention

The present invention relates to the fabrication of shoes and more specifically, to an outsole fabrication method.

2. Description of the Related Art

Regular commercially available aircushion shoes commonly have an airbag of elastic material embedded in the outsole for absorbing shocks during a heavy exercise, so that the user's ankle receives less pressure, and the risk of athletic injury is minimized. Therefore, aircushion shoes are popularly accepted by consumers and are the hot items in market.

FIGS. 11-13 show the fabrication of an outsole according to the prior art. According to this fabrication method, a mold formed of a first die 81 and a second die 82 and an airbag 83 are prepared. The first die 81 and the second die 82 are adapted to mold the shape of the top and bottom sides of the desired outsole 80. The first die 81 has two protruded side plugs 811 and 812 corresponding to the heel at two sides for forming two openings 84 at two opposite sides of the outsole 80. During fabrication, the airbag 83 is positioned in the first die 81 between the two side plugs 811 and 812. Thereafter, the prepared molten polyurethane is filled into the first die 81 over the airbag 83, and then the second die 82 is closed on the first die 81. After hardening of the material, the finished outsole 80 is removed from the mold. When finished, the airbag 83 is embedded in the outsole 80 and partially projecting in the openings 84.

The aforesaid outsole fabrication method is well developed. However, because the airbag 83 is made of an elastic material, it has a dimensional tolerance. After insertion of the airbag 83 in the first die 81, there may be a gap between the periphery of the airbag 83 and each of the side plugs 811 and 812, thereby resulting in a bur A around each opening 84 of the finished outsole 80. Therefore, a secondary deflashing operation with the application of a chemical solution is needed. The applied chemical solution may erode the airbag 83. Further, this secondary deflashing operation greatly increases the manufacturing cost of the outsole because it requires much labor and time. During the deflashing operation, the worker may breathe toxic gas released from the chemical solution.

### SUMMARY OF THE INVENTION

The present invention has been accomplished under the circumstances in view. It is therefore the main object of the present invention to provide an outsole fabrication method, which eliminates a secondary processing process, greatly reduces the manufacturing cost of the outsole, increases the product yield rate, and prevents the workers from breathing in toxic gas.

To achieve this object of the present invention, the outsole fabrication method comprises the steps of: a) preparing a mold and at least one insert, the mold having a cavity for molding an outsole, at least one through hole in communication with the cavity and the atmosphere, and a fence at the periphery of the cavity around the through hole; b) putting the at least one insert into the cavity near the at least one through hole; c) applying a vacuum pumping operation to the at least one through hole to suck the at least one insert and to have the at least one insert be closely attached to the fence; d) filling a molten plastic material into the cavity of the mold; and e) separating the molding thus formed from the mold after hardening of the filled plastic material so as to obtain a finished outsole.

### BRIEF DESCRIPTION OF THE DRAWINGS

FIG. 1 is a schematic drawing showing the structure of a mold constructed according to a first preferred embodiment of the present invention.

FIG. 2 is a top view of the first die of the mold shown in FIG. 1.

FIG. 3 is a schematic drawing showing an airbag type insert put in the cavity of the mold according to the first preferred embodiment of the present invention.

FIG. 4 is a schematic drawing showing the airbag type insert expanded in the cavity of the mold under a vacuum environment according to the first preferred embodiment of the present invention.

FIG. 5 is a schematic drawing showing the structure of a vacuum pump system used in the first preferred embodiment of the present invention.

FIG. 6 is a schematic drawing showing the prepared molten plastic material filled into the cavity of the first die of the mold according to the first embodiment of the present invention.

FIG. 7 is a schematic drawing showing the prepared molten plastic material filled into the cavity of the first die of the mold and the second die closed on the first die according to the first preferred embodiment of the present invention.

FIG. 8 is a perspective view of an outsole made according to the first preferred embodiment of the present invention.

FIG. 9 is a schematic drawing showing two strip-like inserts put in the cavity of the mold according to a second preferred embodiment of the present invention.

FIG. 10 is a perspective view of an outsole made according to the second preferred embodiment of the present invention.

FIG. 11 is a schematic drawing showing a mold formed of a first die and a second die for outsole fabrication according to the prior art.

FIG. 12 is a schematic drawing showing an airbag inserted into the first die according to the prior art.

FIG. 13 is a perspective view of an outsole made according to the prior art.

### DETAILED DESCRIPTION OF THE INVENTION

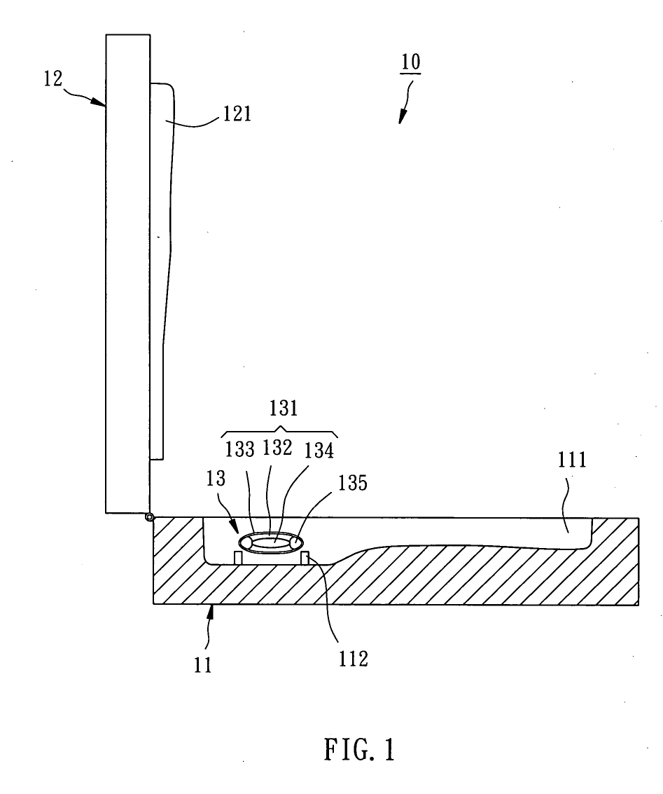

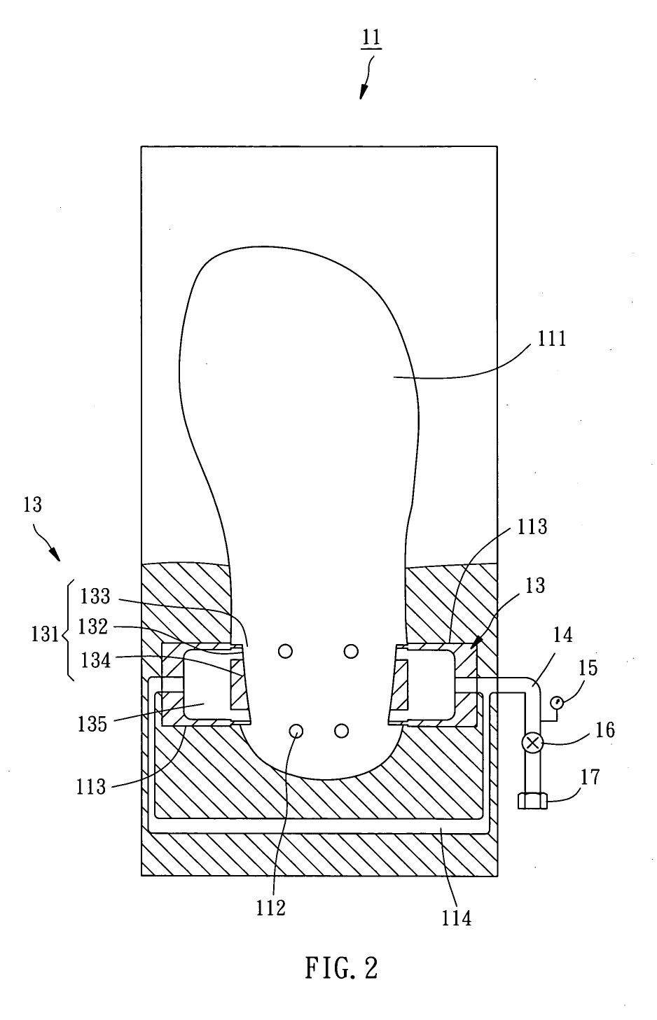

Referring to FIGS. 1-8, an outsole fabrication method in accordance with the present invention includes the steps of:

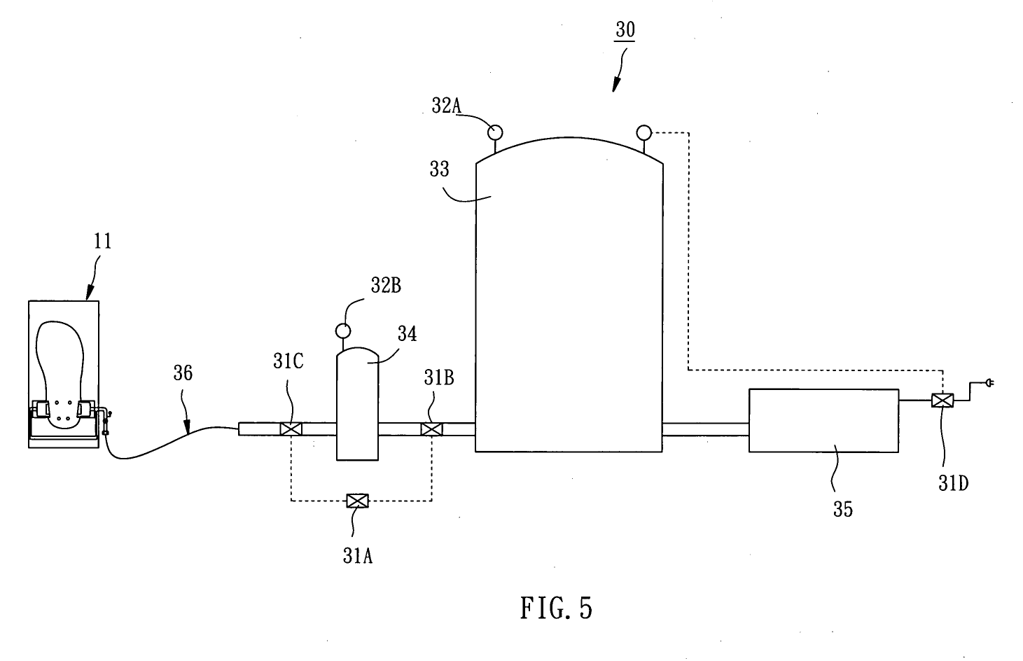

a) preparing a mold 10, an insert 20, and a vacuum pump system 30, as shown in FIGS. 1-3, wherein the mold 10 comprises a first die 11, a second die 12, two plugs 13, a piping 14, a pressure gauge 15, and a control valve 16; the first die 11 has a cavity 111 designed subject to the outsole to be made, four supports 112 disposed in the cavity 111 corresponding to the heel, two receiving holes 113 symmetrically formed in the peripheral wall of the cavity 111 at two sides relative to the supports 112, and a channel 114 that connects the receiving holes 113 to the outside of the first die 11; the second die 12 is pivoted with one end thereof to one end of the first die 11, having a bump 121 corresponding to the shape of the inner side of the outsole to be made and insertable into the cavity 111 of the first die 11; the plugs 13 are respectively mounted in the receiving holes 113 of the first die 11, each having a connecting end 131 projecting out of the respective receiving hole 113 into the cavity 111, an annular groove 132 formed in the connecting end 131 and defining the connecting end 131 into an outer annular fence 133 and an inner bearing portion 134, and a Y-shaped through hole 135, which has two of the three ends thereof connected to the annular groove 132 and the other end connected to the channel 114 in the first die 11 of the mold 10; the piping 14 is a plastic pipe having one end connected to the channel 114 in the first die 11 and the other end provided with a connector 17; the pressure gauge 15 is installed in the piping 14 at an inner side and adapted to measure the pressure inside the piping 14; the control valve 16 is installed in the piping 14 at an outer side and adapted to close the piping 14 and to keep the piping 14 in an enclosed status; the insert 20 is an airbag made of elastic material; the vacuum pump system 30 is comprised of four magnetic switches 31A-31D, two pressure gauges 32A and 32B, a big vacuum tank 33, a small vacuum tank 34, a motor 35, and a flexible tube 36 for vacuum pumping upon start of the motor 35 (see also FIG. 5);

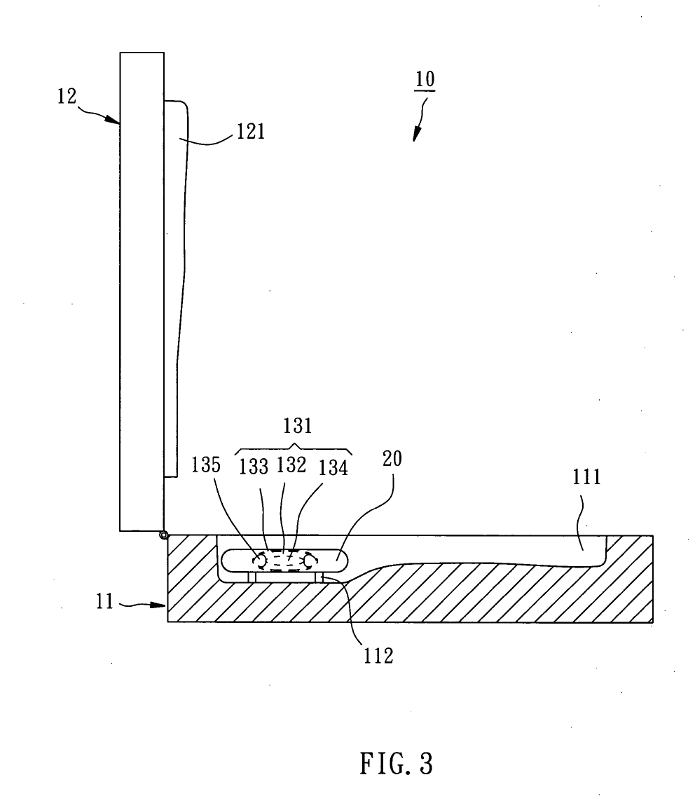

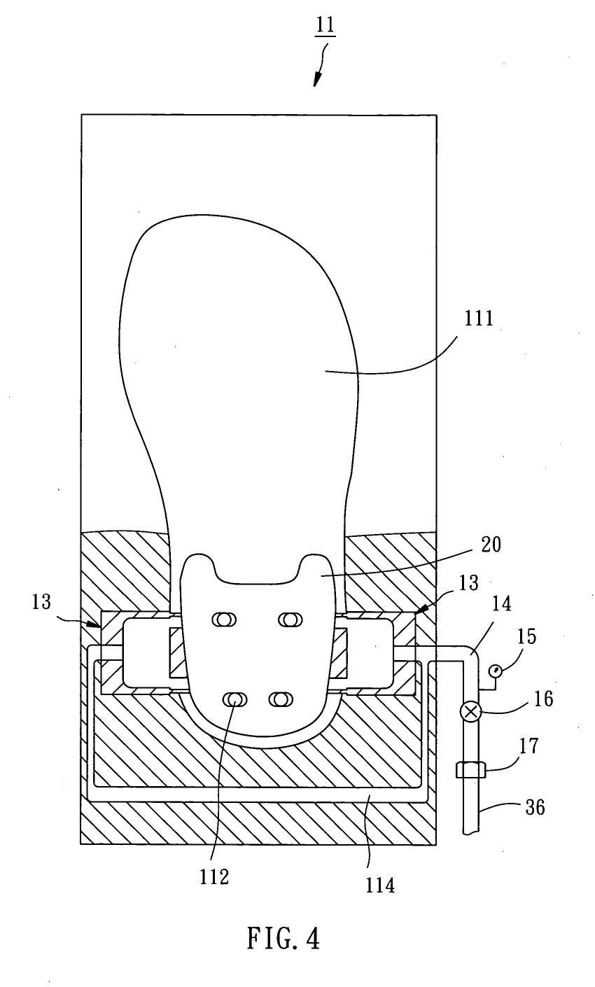

b) inserting the insert 20 into the cavity 111 of the first die 11 and positioning the insert 20 on the supports 112 to have the periphery of the insert 20 set close to the outer annular fence 133 of each of the plugs 13, and then connecting the flexible tube 36 of the vacuum pump system 30 to the connector 17 of the mold 10 as shown in FIGS. 3 and 4;

c) starting the vacuum pump system 30 to draw air out of the mold 10 through the channel 114 and the Y-shaped through hole 135 of each of the plugs 13 as shown in FIG. 5, and then closing the control valve 16 of the mold 10 a few seconds after starting of the vacuum pump system 30 to keep the piping 17 in a negative pressure status and at the same time turning off the motor 35 of the vacuum pump system 30, and then disconnecting the flexible tube 36 from the connector 17 for further connection to a next mold (not shown), at this time, a suction force of negative pressure being produced in the Y-shaped through hole 135 of each of the plugs 13 to suck the elastic insert 20 and to further have the surface of the insert 20 be expanded and adhered to the outer annular fence 133 and inner bearing portion 134 of each of the plugs 13;

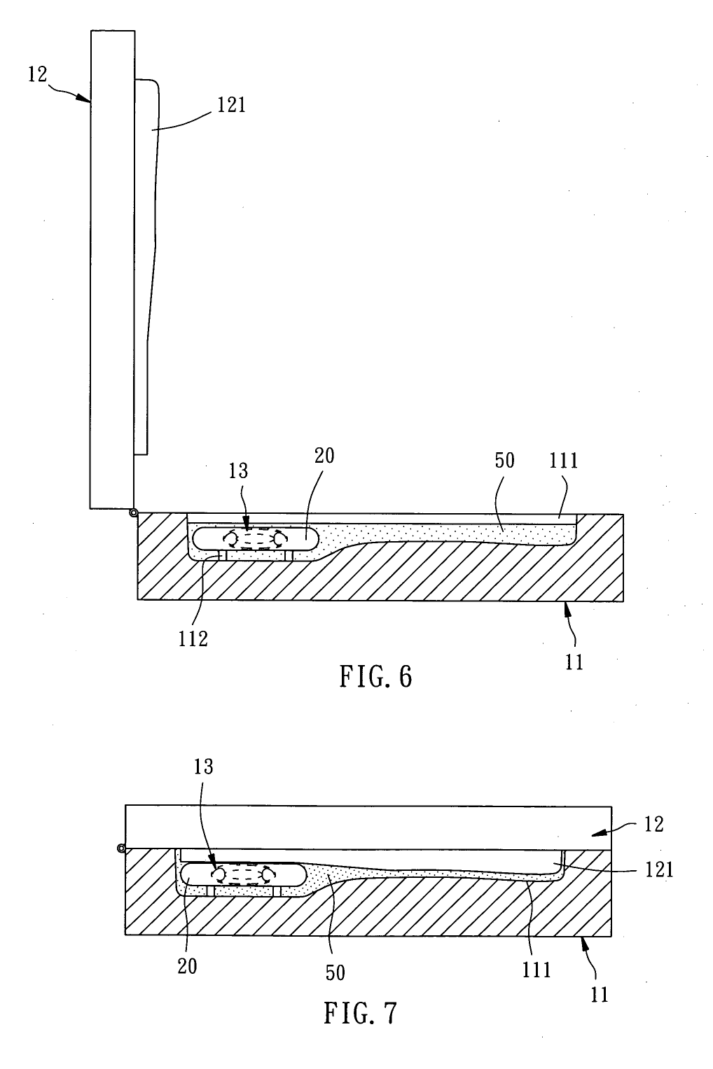

d) filling a certain amount of the prepared molten plastic material, for example, molten polyurethane 50 into the cavity 111 of the first die 11 as shown in FIG. 6;

e) closing the second die 12 on the first die 11 after filling of the prepared molten plastic material 50 into the cavity 111 as shown in FIG. 7; and

f) opening the second die 12 from the first die 11 after hardening of the plastic material 50, and then removing the finished outsole 60 from the mold 10.

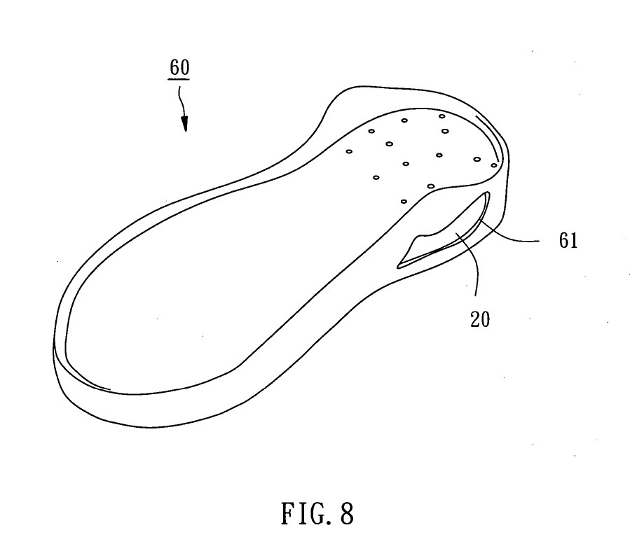

As shown in FIG. 8, the finished outsole 60 has two openings 61 in the peripheral wall at two opposite sides corresponding to the heel, and the insert 20 is embedded in the outsole 60 and partially exposed to the openings 61.

As indicated above, the invention draws air out of the mold 10 to have the periphery of the insert 20 be sucked and closely attached to the outer annular fence 133 of each of the plugs 13 so that the prepared molten plastic material 50 is prohibited to flowing in between the insert 20 and the plugs 13 when it is filled into the cavity 111. Therefore, there is no flash or bur around the border of the openings 61 after finishing of the outsole 60, and it is not necessary to proceed with a secondary chemical deflashing process that may cause the workers to breathe in toxic gas. In general, the finished outsole 60 has a nice looking. Further, the inner bearing portion 134 of each of the plugs 13 prohibits excessive deformation of the insert 20 during the vacuum pumping operation.

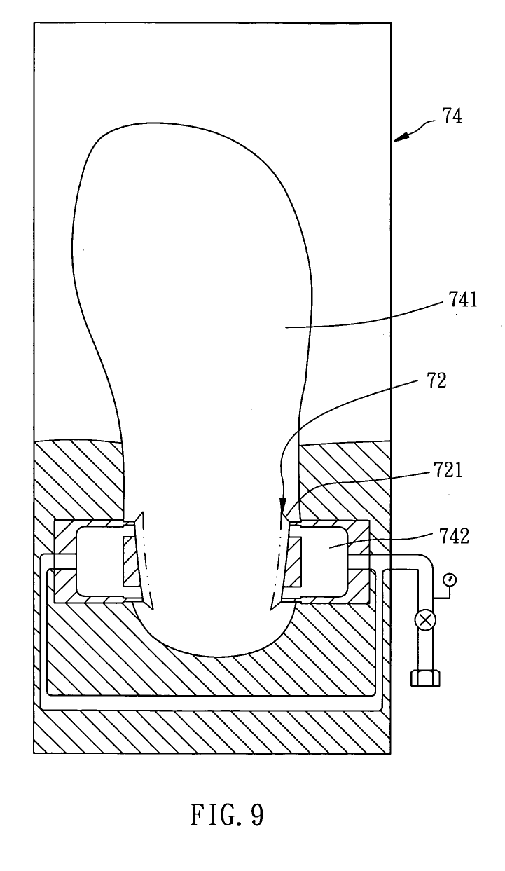

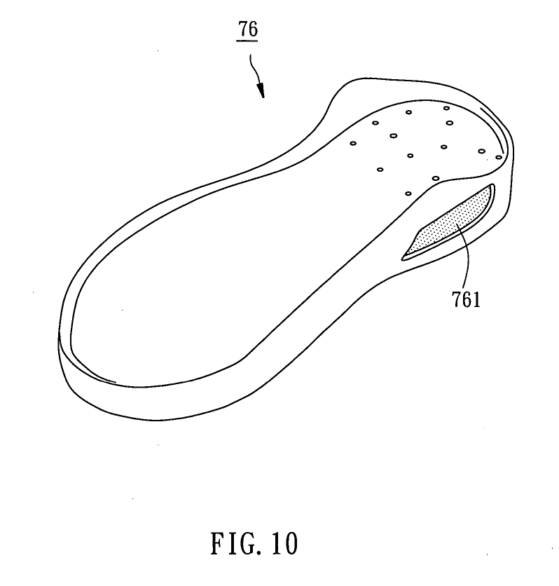

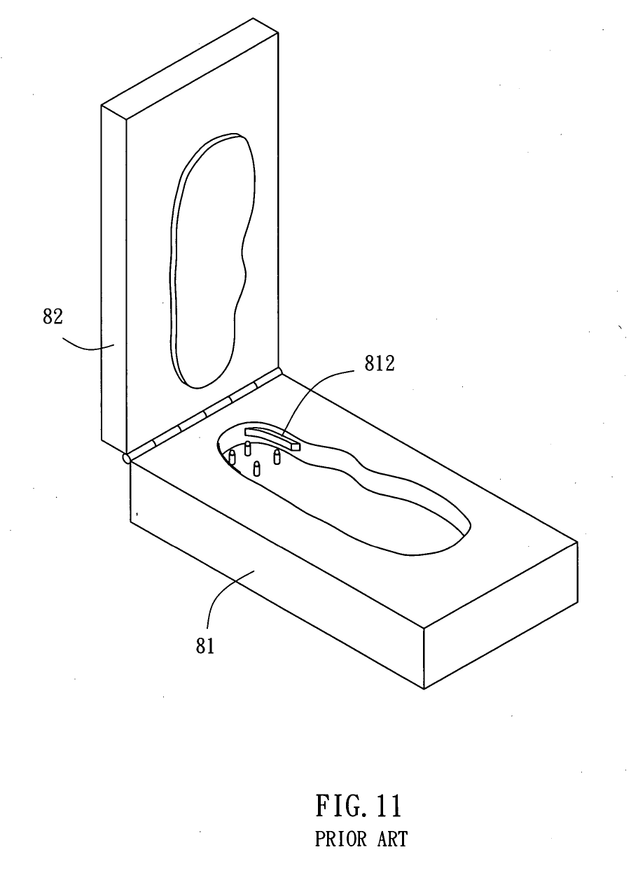

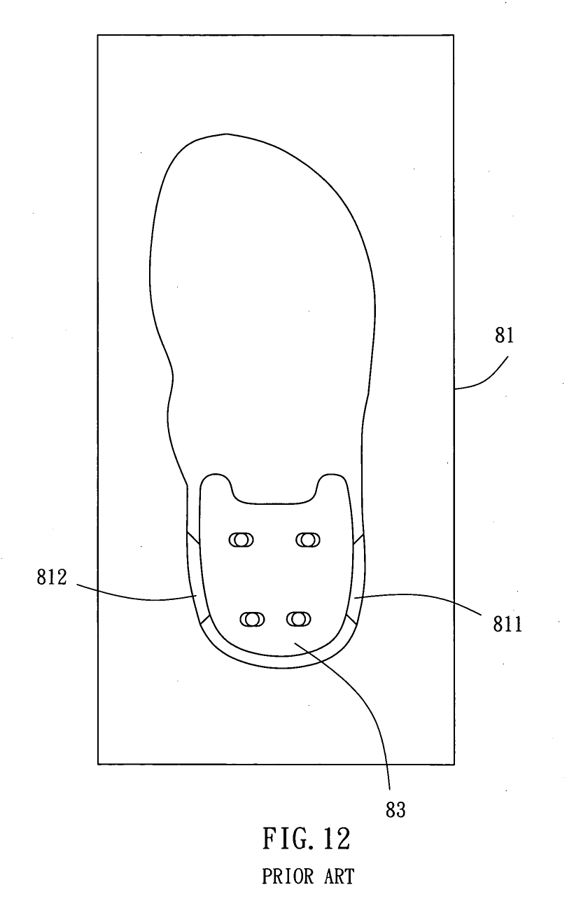

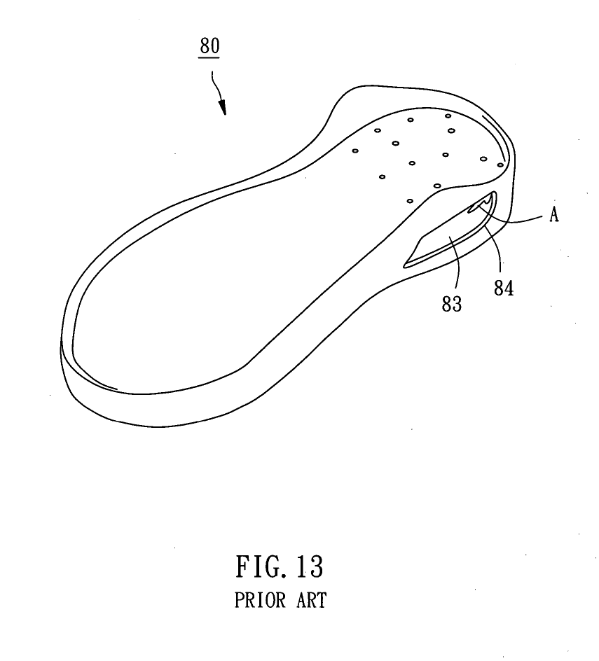

As stated above, the invention mainly uses a vacuum pumping operation to prevent overflow of the filling molten plastic material during molding of the outsole. However, the insert is not limited to an airbag. FIGS. 9 and 10 show an alternate form of the present invention. According to this embodiment, two strip-like inserts 72 are used instead of the aforesaid airbag. The two strip-like inserts 72 are put in the cavity 741 of the mold 74 and respectively set close to the through hole 742 of the respective plug. Further, each strip-like insert 72 has an outer surface 721 facing the respective through hole 742. The outer surface 721 may be embossed or printed with a design. When the outsole 76 is finished, the outer surface 721 (the design of the outer surface) of each of the two strip-like inserts 72 can be seen through the openings 761. Further, the mold used for molding the desired outsole can be formed of more than two dies.

What is claimed is:

1. A method of making an outsole comprising the steps of:
a) preparing a mold and at least one insert, said mold having a cavity for molding an outsole, at least one through hole in communication with said cavity and the atmosphere, and a fence at a periphery of said cavity around said through hole;
b) putting said at least one insert into said cavity near said at least one through hole;
c) applying a vacuum pumping operation to said at least one through hole to suck said at least one insert and to have said at least one insert be closely attached to said fence;
d) filling a molten plastic material into said cavity of said mold; and
(e) separating the molding thus formed from said mold after hardening of the filled plastic material so as to obtain a finished outsole.

2. The method as claimed in claim 1, wherein said insert is an airbag.

3. The method as claimed in claim 1, wherein said insert is a solid member.

4. The method as claimed in claim 1, wherein said plastic material is polyurethane.

5. The method as claimed in claim 1, wherein said mold comprises a first die and a second die, said first die comprising said cavity and said at least one through hole and a channel connecting said at least one through hole to the atmosphere, said second die being pivoted to said first die and having a bump insertable into said cavity.

6. The method as claimed in claim 5, wherein said first die further comprises a plurality of supports suspending in said cavity corresponding to the heel of the outsole to be made for supporting said at least one insert in said cavity.

7. The method as claimed in claim 1, further comprising a sub-step of preparing a vacuum pumping system and a flexible tube and connecting said vacuum pumping system to said at least one through hole by said flexible tube after preparation of said mold and said at least one insert during step a).
